(19) United States
(12) Patent Application Publication
(10) Pub. No.: US 2009/0171912 A1
(43) Pub. Date: Jul. 2, 2009

(54) Disambiguation of a structured database natural language query

(76) Inventors: Michael Patrick Nash, Saskatoon (CA); Ryan Scott Breidenbach, Coppell, TX (US); Roderick F. Coffin, III, Dallas, TX (US); Kelly Christopher Fox, Austin, TX (US); Ben Rady, Dallas, TX (US); Daniel L. James, Annetta, TX (US); Paul Randolph Holser, JR., Addison, TX (US); Ruby Bailey, McKinney, TX (US); Craig Walls, Plano, TX (US); Ravi Varanasi, Richardson, TX (US)

Correspondence Address: Steven Thrasher, 391 Sandhill Dr., Richardson, TX, 75080, US

(21) Appl. No.: 12/151,380

(22) Filed: May 6, 2008

Related U.S. Application Data
(60) Provisional application No. 61/009,815, filed on Jan. 2, 2008.

(51) Int. Cl. G06F 7/06

(52) U.S. Cl. 707/3; 707/E17.015

(57) ABSTRACT

The invention compares a user-generated inquiry to a known data source in order to present a user with a choice of valid natural language inquiries. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CROSS-REFERENCE TO RELATED APPLICATION

The invention is related to and claims priority from pending U.S. Provisional Patent Application No. 61/009,815 to Lane, et al., entitled NATURAL LANGUAGE DATABASE QUERYING filed on 2 Jan. 2008.

### TECHNICAL FIELD OF THE INVENTION

The present invention relates generally to structured data querying, and more particularly to natural language database querying.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

Any given natural language inquiry, intended to be directed against a data source that may contain precise answers to that inquiry, may be mapped to one or more concepts and relations, if any, between those concepts. Each concept may be constrained or filtered by either its relation to other concepts—such as “show me all of the customers who have placed orders”—or by desired values of attributes of that concept—such as “show me all of the orders with status ‘Q’”—or by any combination of these, such as “show me all of the customers who have placed orders where those orders have status ‘Q’”. Assuming that the user seeks specific information, each constraint reduces the size of the overall result set, making the results more targeted by having the characteristics the user is looking for.

One structured form (used above) is the structure called the Minimally Explicit Grammar Pattern (“MEGP”) which is discussed in co-owned and co-pending U.S. patent application Ser. No. ______. Thus, an inquiry may be formed using MEGP. In addition to forming an inquiry, an additional use of MPEG is in the disambiguation of more free-form inquiries (that is to say, more free-form than MEGP), as this is more likely to suit the type of inquiry that a user might form when speaking to another human, as opposed to a computer system.

In other words, for existing database inquiries, as long as the user precisely articulates the inquiry grammar and syntax, the data he wants can typically be found. However, database inquiries frequently result in error messages that boil down to this: the data the user wants can't be found because the user either has not mastered the database inquiry grammar and syntax, or because he has made a mistake when entering the inquiry. This is particularly the case when users create inquiries using systems that are more and more free-form in nature. Accordingly, there is needed a system and method for “bridging” the gap between what a user enters as an inquiry, and an inquiry that the target data source understands with precision.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is an exemplary concept model.

FIG. 2 illustrates the Minimally Explicit Grammar Pattern (MEGP) syntax.

FIG. 3 is a flowchart of a disambiguation algorithm.

FIG. 4 is a portion of a graphically represented concept model for a Customer Relationship Management (CRM) database.

FIG. 5 is a partial concept model for the CRM database, reflecting a user's inquiry.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Computing platforms are computers, such as personal computers, workstations, servers, or sub-systems of any of the aforementioned devices. Further, a computing platform may be segmented by functionality into a first computing platform, second computing platform, etc. such that the physical hardware for the first and second computing platforms is identical (or shared), where the distinction between the devices (or systems and/or sub-systems, depending on context) is defined by the separate functionality which is typically implemented through different code (software).

Of course, the foregoing discussions and definitions are provided for clarification purposes and are not limiting. Words and phrases are to be given their ordinary plain meaning unless indicated otherwise.

### DESCRIPTION OF THE DRAWINGS

A minimally explicit grammar pattern (MEGP) is in one aspect a system for expressing what a user intends to find as the result of a database inquiry in an explicit way such that ambiguity is removed from the query. Stated another way, functionally, MEGP is a compromise between entering a true free-form natural language query, and having to either type a structured query and/or use a menu-driven query system. As a system, MEGP defines a syntax and set of words that are a subset of a user's natural language, and which map to known concepts, values, logical relationships, relations, and/or comparators. This discussion incorporates the teachings of co-pending and co-owned U.S. patent application Ser. No. 11/______ to Lane, et al. filed on 31 Jan. 2008, entitled DOMAIN-SPECIFIC CONCEPT MODEL FOR ASSOCIATING STRUCTURED DATA THAT ENABLES A NATURAL LANGUAGE QUERY, which is incorporated herein by reference in its entirety. Of course, it is understood that those terms used herein are readily apparent and understood by those skilled in the art of conceptual databases upon reading this disclosure.

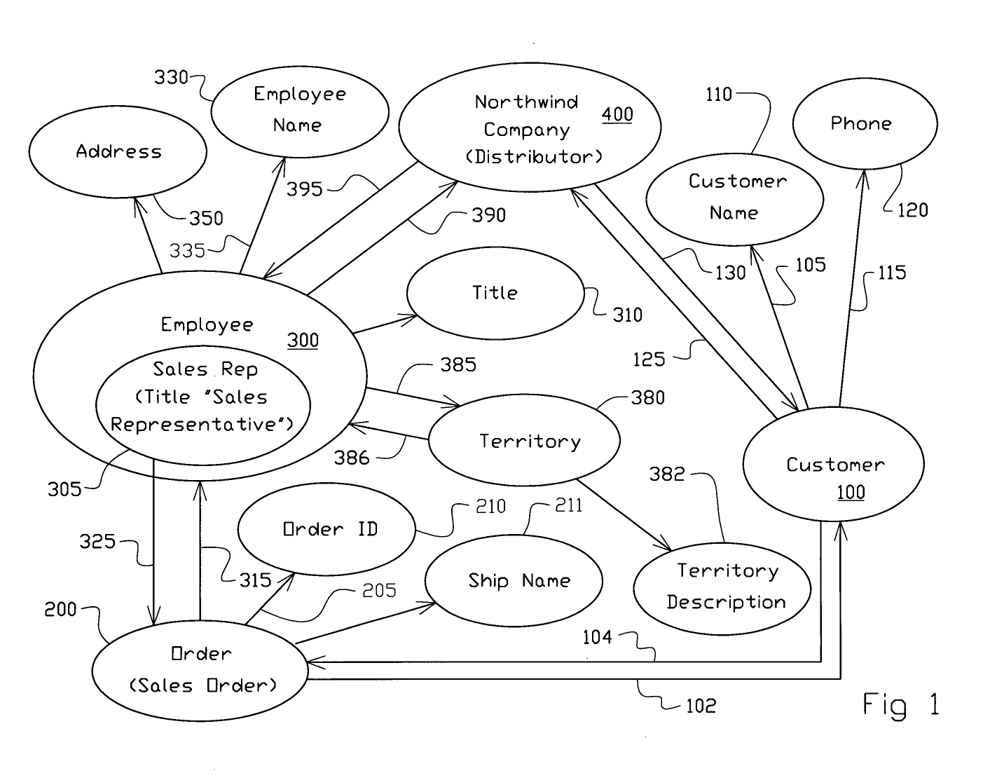

FIG. 1 is an exemplary concept model. The concept model comprises a customer concept 100, an order concept 200, a company concept 400, and an employee concept 300 that wholly includes a sales rep property 305. The customer concept 100 is related to property “customer name” 110 by relation “named” 105, and property phone 120 by relation “having phone” 115. Customer concept 100 is related to company concept 400 by the “buys from” relation and the “sells to” reverse relation, as well as the order concept 200 via the “who placed” relation 104 and the “placed by” 102 reverse relation. Order concept 200 is related to the “order ID” property 210 via the “having ID” relation 205. Further, the order concept 200 is related to both the employee concept 300 and the “sales rep” property 305 via the “written by” relation 315 and the “who wrote” reverse relation 325.

The employee concept 300 is related to the company concept 400 via an “employed by” relation 390 and an employs relation 395 (which is a reverse-relation of the “employed by” relation 390). In addition, the employee concept 300 includes an “employee name” property 330 related by a “having name” relation 335, and an address external abstraction 350 related by the “working at address” relation 355.

The employee concept 300 is further related to a territory attribute 380 via an “assigned to” relation 385 and a second “assigned to” reverse concept 386. The territory attribute 380 is further related to a “territory description” property 382 via a “named” relation 383.

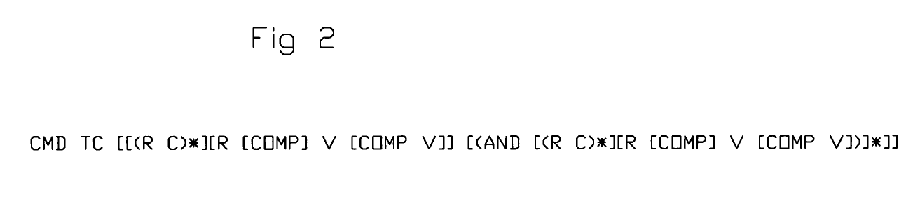

FIG. 2 illustrates the MEGP syntax. This syntax is part-and-parcel to a methodology of providing a user the ability to find specific data, without ambiguity, using a subset of that user's natural language in a subject area. In describing the methodology of entering a query using the MPEG syntax, reference is made to Table 1, below, which is a legend of the MPEG syntax nomenclature. It should be noted that the employment of synonyms is provided in the MEGP model, and the incorporation of synonyms is indicated in the following table as indicated by the “#” symbol.

TABLE 1
LEGEND OF MPEG SYNTAX NOMENCLATURE.

| ABBREVIATION/ | |
|---|---|
| SYMBOL | REPRESENTATION |
| CMD | Command. Example: “list”, “count”. # |
| TC | Target Concept. Single or multi-word; |
| | columns & rows returned for TC only. # |
| C | Concept. May be a Specialized Concept. # |
| V | Value. Exact match of one or more words (not |
| | case sensitive). |
| AND | The literal word “AND” or equivalent |
| | conjunction; not case sensitive. |
| R | Relation. Exact match of one or more words. |
| | Directionally unique for each concept. # |
| COMP | Comparitor. Ex) dates, “since”, “after”, |
| | “before”, “through”, “on”, “from/to”. <> =. # |
| [ ] | That which within is OPTIONAL. |
| * | Repeat. |

### General Methodology

Before discussing a specific MPEG, one should consider the invention from a “high”/generic level. One embodiment of the inventive method begins when a database query is begun when a computer system accepts an input comprising words (and, in some cases only words), where the input is restricted to a predefined syntax comprising a predefined set of words, in a known order, from a first known subject area, and an answer comprising a datum is generated in response to that database inquiry. The methodology preferably seeks to avoid returning “garbage” by validating that the input matches an expected structure before running any query on a target data source. Where a conceptual data model is employed, the method maps the words to a conceptual inquiry.

### More Specific MPEG Query Methodology

With more particular reference to FIG. 2, one embodiment of the invention can be recognized as a method for providing a user the ability to find specific data without ambiguity using a subset of that user's natural language in a subject area. Here, a user enters a search that locates structured data in a database, where the search “grammar” is predefined, here particularly to include mandatory elements comprising a command (such as “find”) and a target concept (such as “sales”), and a set of optional elements comprising at least either a relationship R (such as “exact match”) or a value V (such as ‘X’) having a comparator such as “equal to ______.”

Accordingly, a command CMD may define an output type, such as “list”, “show”, “table” or “print.” The target concept TC is the first concept chosen, and is selected from a group of concepts, the group of concepts being predefined associations of sets of data. In addition, a relation R defines how a concept is related to either a value, comparator or another concept. Thus, the relationship “R” is in one embodiment associated with a comparator, or in other words, a relationship “R” is associated with a value “V” via a comparator. Similarly the value “V” may be associated directly with a comparator (“equal to 1000”). Similarly, the comparator may be associated with a second value “V.” Comparators may also define a mathematical, spatial, temporal, or logical relationship. The set of optional elements may include a second relationship “R” and a concept “C” related to the second relationship. Further, as is indicated by brackets “[ ]” in FIG. 2, the grammar may include additional optional elements and optional sets of elements, such as a second set of optional elements, or even a third relationship and a concept related to the third relationship. In the preferred embodiment, the second set of optional elements comprises a relationship and a concept.

### Example 1

The following is an example of building a MEGP search on data accessible by the concept model of FIG. 1. Here, a user enters a MEGP search into the system: “list customers who placed orders written by employees assigned to territory named Texas.” The MEGP follows the concept model, so that a user who knows the MPEG grammar and syntax may flawlessly enter a search. Here, the command CMD “list” is followed by the target concept TC “customer(s).” Next, the user lists a relation R “who placed” followed by a concept C “order.” This R C pattern may be repeated as called for by the user within the confines of the then in-use concept model—for example, here the user enters another relation R “written by” and another concept C “employees.” The next relation R identifies that the employees are “assigned to” the abstract concept C “territory” having a relation R “named” to the property value V “Texas.” This is expressed in the inventive MEGP as CMD TC R C R C R C R V.

### Example 2

This time, a user enters a MEGP search into the system: “list orders placed by customers named “Smith” AND written by employees having name Jones.” Again, the MEGP follows the concept model, so that a user who knows the MPEG grammar and syntax may flawlessly enter a search. Here, the command CMD “list” is followed by the target concept TC “orders” which is related by relation R “placed by” another concept “customers” having a relation R “named” to the value V “Smith” via the relation R “placed by”. Here, the user wants to establish an answer that is generated from two concepts that are treated independently as a user “traverses” the concept model—the “orders” and the “written by” concepts. Accordingly, the user joins these independent concepts by using a logical conjunction “AND.” Specifically, in this example, after entering the AND join, the user enters a new relation R “written by” concept “employees” having a relation R “named” to the value V “Jones”. This is expressed in the inventive MEGP as CMD TC R C R V AND R C R V.

### Example 3

This time, a user enters a MEGP search into the system: “count employees who wrote orders valued at >999.” Again, the MEGP follows the concept model, so that a user who knows the MPEG grammar and syntax may flawlessly enter a search. Here, the command CMD “count” is followed by the target concept TC “employees” which is related by relation R “who wrote” to another concept “orders” having a comparator COMP of “>” or its synonym “greater than” the value V “999.” This is expressed in the inventive MEGP as CMD TC R C R COMP V. As in the other two examples, the user is entering a search that is much more natural to the user than an SQL query.

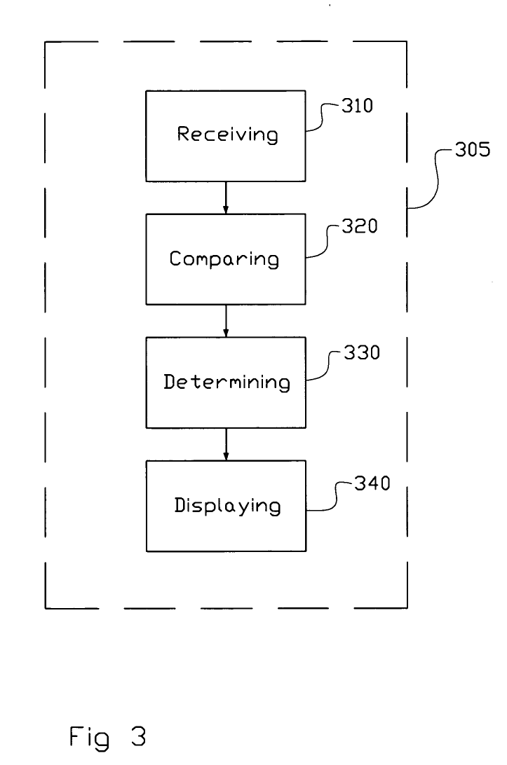

FIG. 3 is a flowchart of a disambiguation algorithm. The disambiguation algorithm preferably runs (that is to say, is “executed”) on a processor and is used to find data in a data source 300 maintained in memory. Accordingly, the disambiguation algorithm is executable as a method for suggesting inquiry choices to a user of a structured database. The structured database is associated with a first concept mode—indeed, the first concept model is derived from the structured database. The structured database is preferably searchable via a natural language inquiry, and in a preferred embodiment is searchable via MEGP. The natural language inquiry defines an inquiry that returns a valid result to the inquiry—for purposes of the disambiguation algorithm, the correct natural language inquiry is a known and predefined structured form (in other words, it is a correctly worded and syntaxed inquiry), whereas a user inquiry may deviate from the known and predefined structured form, and thus may be either incorrectly worded or syntaxed.

Accordingly, the method begins in a receiving act 310 wherein the algorithm receives a natural language user inquiry for retrieving information from the structured database. Next, in a comparing act 320 the user inquiry is compared to the known and predefined structured form of the underlying data source. Then, in a determining act 330, at least one plausibly correct inquiry, based on the user inquiry, is generated, and in a displaying act 340, the plausibly correct inquiry(ies) is displayed to the user.

Additional functionality and features may be provided to a user by statistically determining a preference for at least one of two plausibly correct inquiries. The preference could be based on historical user choices (historical as to a specific user, a work group, or across an enterprise). If the inquiry representing the inquiry the user intended to enter is displayed (a correct inquiry), the user will identify it, and the system will thus receive the user selection of one of the plausibly correct inquiries.

The data source structure may be graphically represented as disclosed in co-owned and co-pending U.S. patent application No. 11/______ to Nash, et al., which is incorporated herein by reference in its entirety. Accordingly, in a mapping act the concept model is mapped as a concept model graph for user-display by a graphical user interface. In addition, it is desirable to map and display the user inquiry as a user inquiry graph. By displaying the user-inquiry graph and the concept model graph on a graphical user interface, a user sees both the overlap and divergences between the data structure(s) suggested by user inquiry and the actual database data structure. These similarities and differences thus suggest to the user how to modify/correct their user inquiry to get to the precise data the user wants. In one embodiment, the system automatically compares the user inquiry graph with the concept model graph to determine at least one “best-fit” of the user-inquiry graph to the concept model graph. Then, in a user-selection act the system accepts a user choice of one of the plausibly correct inquiries.

### Example 4

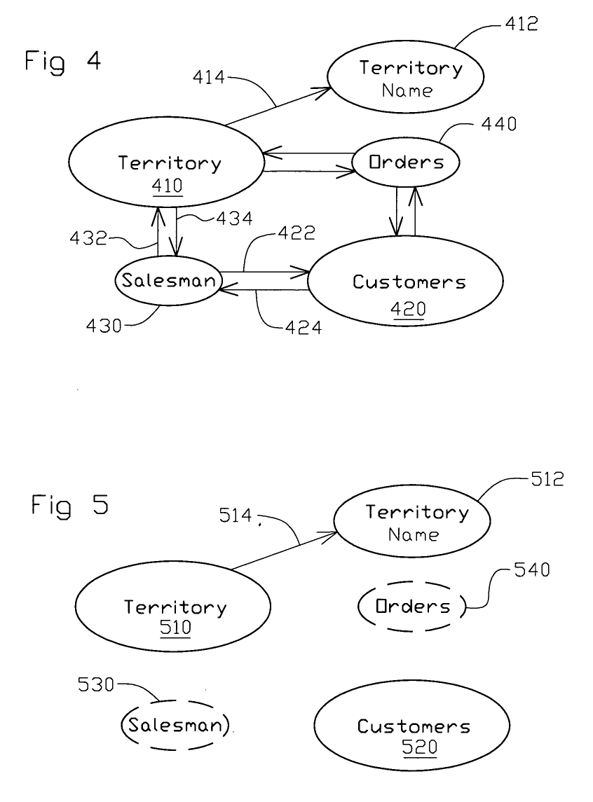

When the elements of any inquiry are mapped to concepts, relations, and values, a graphical representation of the inquiry may be constructed. This graphical representation may take the form of a (possibly incomplete) graph, where each node in the graph represents a concept (selected from a domain of known concepts) or an attribute of a concept, and a connection between nodes represents relations between nodes (between concepts or between a concept and its attributes). Better understanding of this may be gained by referring to figures four and five, in which FIG. 4 is a portion of a graphically represented concept model for a Customer Relationship Management (CRM) database, and FIG. 5 is a partial concept model for the CRM database, reflecting a user's inquiry.

In FIG. 4, there is shown a concept model having concept called territory 410 having an attribute called “territory name” 412 associated therewith via a “named” relation 414. Additional concepts shown include customers 420, salesmen 430 and orders 440. Territory 410 relates to salesmen 430 via a “located in” 432 and a having 434 relations. In addition, salesmen 430 relates to customers 420 via a “who sold to” 422 and a “who bought from” 424 relation. Relations known as “placed by” 426 and “who placed” 428 relate the customers 420 concept to the orders 440 concept. Further, territory 410 is related to orders 440 via a placed 446 relation and a “sent to” 448 relation. Each relation illustrated indicates the manner of which concept is being related to the other concept or attribute. Furthermore, the concept model of FIG. 4 is understood to have numerous other concepts, attributes, relations and other values not illustrated so as to minimize ambiguity.

An inquiry may be ambiguous when examined in the context of a given “correct” concept model for a domain, where the correct concept model contains all allowed concepts, attributes, and relations between them. For example, the graph of the user inquiry may contain references to nodes which are not directly connected by a relation, and further, may have more than one path which connects them, optionally passing through other nodes. For example, in reference to FIG. 5, the user inquiry: “give me all northern customers” could be mapped to the nodes “territory (a concept)” 510, “northern (a value of a attribute)” 512, “named” 514 (the line joining northern to its owning concept, called “territory”, and the concept called “customers” 520. Let us assume for this discussion that both orders 540 and salesman 530 are related to territory 510, and that orders 540 and salesmen 530 are also both related to customers 520. In order to produce a complete graph with all necessary nodes to represent a non-ambiguous interpretation of this inquiry, a choice must be made between the path that uses “salesman” 530 or the path that uses “orders” 540 to connect a customer 520 to a territory 510, 512.

As is illustrated in FIG. 5, there are two possible paths of completing the user inquiry (that is to say, placing the user inquiry into a form that is in conformity with the grammar and syntax associated with the underlying data structure). Each or both options may be illustrated as completed graphs representing these two choices, and the example can be represented by a canonical form able to be understood clearly and non-ambiguously by the user of a given system. This allows feedback from the user to either enter a correct inquiry based on the shown guidance, or to select the correct interpretation of the original inquiry, this disambiguating and producing a conceptual inquiry that may be processed further into an actionable query against a data source to produce the desired precise answer.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A system for suggesting inquiry choices to a user of a structured database, comprising:
a memory having
a data source, the data source being a structured database, and
a first concept model derived from the structured database;
processing adapted to
receive a user inquiry, the user inquiry for retrieving information from the structured database,
the structured database being searchable via a natural language inquiry, the natural language inquiry defining an inquiry that returns a valid result to the inquiry,
a correct natural language inquiry having a known-predefined structured form,
the user inquiry deviating from the known and predefined structured form,
compare the user inquiry to the known and predefined structured form,
determine one or more plausibly correct inquiries based on the user inquiry, and
display the plausibly correct inquiries.

2. The system of claim 1 wherein the processor is further adapted to statistically determine a preference for at least one of two plausibly correct inquiries.

3. The systems of claim 1 wherein the processor is further adapted to determine a preference for each plausibly correct inquiry based on historical user choices.

4. The systems of claim 1 wherein the processor is further adapted to receive a user selection of one of the plausibly correct inquiries.

5. The systems of claim 1 wherein the processor is further adapted to map the concept model as a concept model graph for user-display by a graphical user interface.

6. The systems of claim 5 wherein the processor is further adapted to map the user inquiry as a user inquiry graph for user-display by a graphical user interface

7. The systems of claim 6 wherein the processor is further adapted to compare a user inquiry graph with the concept model graph to determine at least one best-fit of the user-inquiry graph to the concept model graph.

8. The systems of claim 1 wherein the processor is further adapted to display the user-inquiry graph and the concept model graph on a graphical user interface.

9. The systems of claim 1 wherein the processor is further adapted to accept a user choice of one of the plausibly correct inquiries.

10. A method for suggesting inquiry choices to a user of a structured database, comprising:
receiving a user inquiry, the user inquiry for retrieving information from a structured database;
the structured database having a first concept model derived therefrom;
the structured database being searchable via a natural language inquiry, the natural language inquiry defining an inquiry that returns a valid result to the inquiry,
defining a correct natural language inquiry as a natural language inquiry having a known and predefined structured form,
the user inquiry deviating from the known and predefined structured form,
comparing the user inquiry to the known-predefined structured form,
determining one or more plausibly correct inquiries based on the user inquiry, and
displaying the plausibly correct inquiries.

11. The system of claim 10 further comprising statistically determining a preference for at least one of two plausibly correct inquiries.

12. The systems of claim 10 further comprising determining a preference for each plausibly correct inquiry based on historical user choices.

13. The systems of claim 10 further comprising receiving a user selection of one of the plausibly correct inquiries.

14. The systems of claim 10 further comprising mapping the concept model as a concept model graph for user-display by a graphical user interface.

15. The systems of claim 14 further comprising mapping the user inquiry as a user inquiry graph for user-display by a graphical user interface

16. The systems of claim 15 further comprising comparing a user inquiry graph with the concept model graph to determine at least one best-fit of the user-inquiry graph to the concept model graph.

17. The systems of claim 16 further comprising displaying the user-inquiry graph and the concept model graph on a graphical user interface.

18. The systems of claim 17 further comprising accepting a user choice of one of the plausibly correct inquiries.
